(19) United States
(12) Patent Application Publication
(10) Pub. No.: US 2008/0309558 A1
(43) Pub. Date: Dec. 18, 2008

(54) MICRO ANTENNA STRUCTURE

(76) Inventor: Yao-Wen YU, Pa-Te City (TW)

Correspondence Address: SINORICA, LLC, 528 FALLSGROVE DRIVE, ROCKVILLE, MD, 20850, US

(21) Appl. No.: 11/763,321

(22) Filed: Jun. 14, 2007

(51) Int. Cl. H01Q 1/38

(52) U.S. Cl. 343/700 MS

(57) ABSTRACT

A micro antenna structure composed of a base plate and an antenna structure, a grounding surface and a clear space are formed on the base plate. The antenna structure is provided in the clear space and includes a radiation element and a fixing plate; the fixing plate is made of material for making a printed circuit board, while the radiation element is made from copper foils and is laid out linearly on the fixing plate. With this structure, the problem of having complicated procedure of processing and high cost of a conventional micro chip antenna can be eliminated here, and a good effect can be attained by using minimum space; thereby the weight and volume of a mobile communication product can be reduced but a good effect can be attained.

### BACKGROUND OF THE INVENTION

1. Field of the Invention

The present invention relates to a micro antenna structure, and especially to an antenna structure having a fixing plate made of material for making a printed circuit board to be laid out linearly thereon a radiation element which is made from copper foils.

2. Description of the Prior Art

By virtue that mobile communication products, such as mobile phones, are required to be compacted and multifunctional, their antenna structures (from exposed antennas, hidden planar antennas to the advanced micro chip antennas) must occupy smaller volumes to meet the tendency of designing of mobile communication products.

The structure of such a micro chip antenna mainly has a radiator layer laid out on a dielectric layer and is sealed and packaged.

These micro chip antennas can meet the requirement of reducing volume occupied, but they largely increase the costs of production, particularly because laying out of the radiators in the chip structures and the design of connecting pins extending outwards become more and more complicated, this is disadvantageous to competition of communication products. And some ceramic chip antennas, when in simulation of the real situation, need large clear spaces for getting good effects; however, the effects always become inferior after assembling the antennas in devices, and thereby improvement is required.

### SUMMARY OF THE INVENTION

The present invention provides a micro antenna structure composed of a base plate and an antenna structure. A grounding surface and a clear space are formed on the base plate. The antenna structure is provided in the clear space and includes a radiation element and a fixing plate; the fixing plate is made of material for making a printed circuit board, while the radiation element is made from copper foils and is laid out linearly on the fixing plate. With this structure, the problem of having complicated procedure of processing and high cost of a conventional micro chip antenna can be eliminated, and a good effect can be attained by using minimum space; thereby the weight and volume of a mobile communication product can be reduced but a good effect can be attained.

And more, in designing, the range of the clear space between the antenna structure and the grounding surface of the present invention is reduced, so that in simulation of the real situation and assembling the present invention in a device, error by variation of the effect of the antenna structure can be lowered to the minimum range.

The present invention will be apparent in its structure and effect after reading the detailed description of the preferred embodiment thereof in reference to the accompanying drawings.

### BRIEF DESCRIPTION OF THE DRAWINGS

FIG. 1 is a perspective view showing the appearance of an embodiment of the present invention;

FIG. 2 is a plane view of the embodiment of FIG. 1;

FIG. 3 is a perspective view of an antenna structure of the present invention;

FIG. 3A is a top view of the embodiment of FIG. 3;

FIG. 3B is a front view of the embodiment of FIG. 3;

FIG. 4 is a test chart showing the return loss of the present invention on an electric device;

FIG. 5 is a standing wave ratio test graph of the present invention on an electric device.

### DETAILED DESCRIPTION OF THE PREFERRED EMBODIMENT

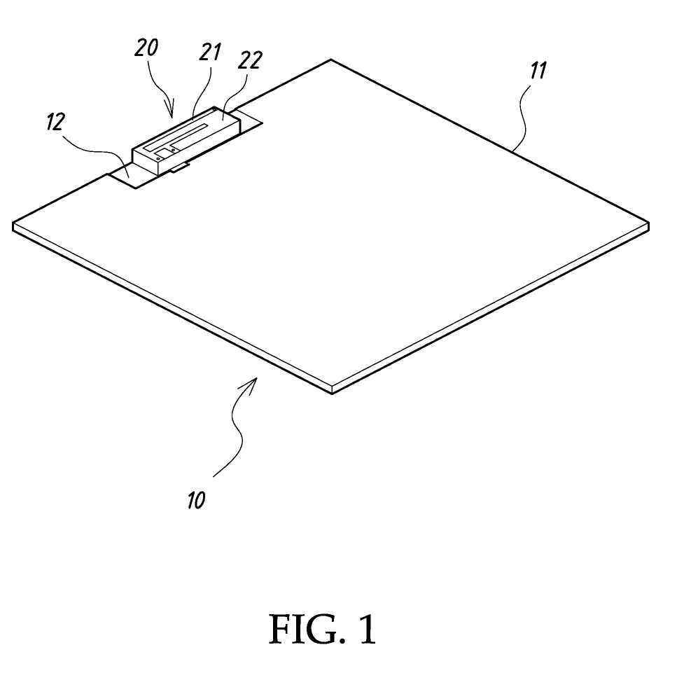

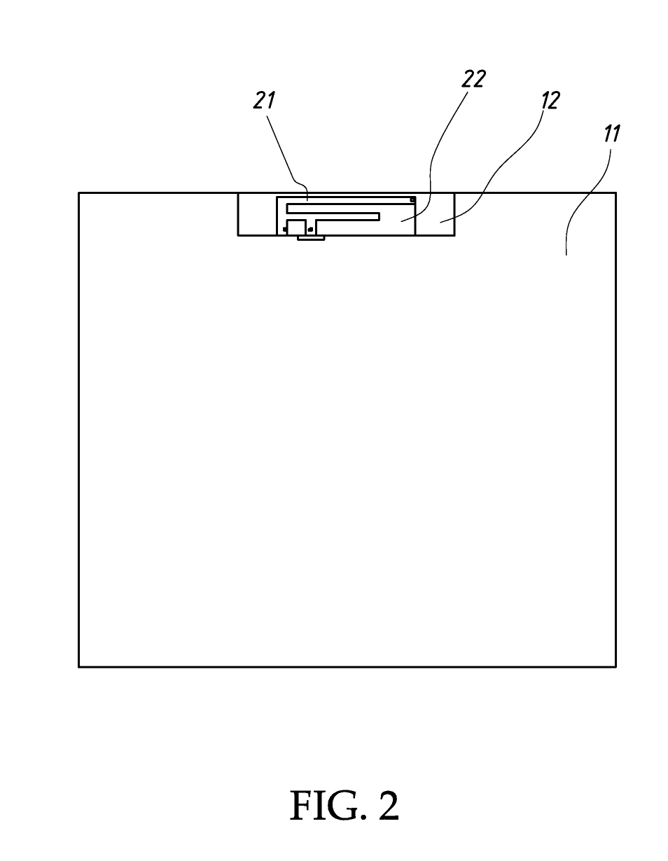

Referring to FIGS. 1 and 2, a micro antenna structure of the present invention comprises a base plate 10 and an antenna structure 20.

The base plate 10 is formed thereon a grounding surface 11 and a clear space 12 which is provided at the middle of an edge of the base plate 10; the size of the clear space 12 is 20 mm×4.2 mm, and as is shown in FIG. 2, there is no any metal to interfere.

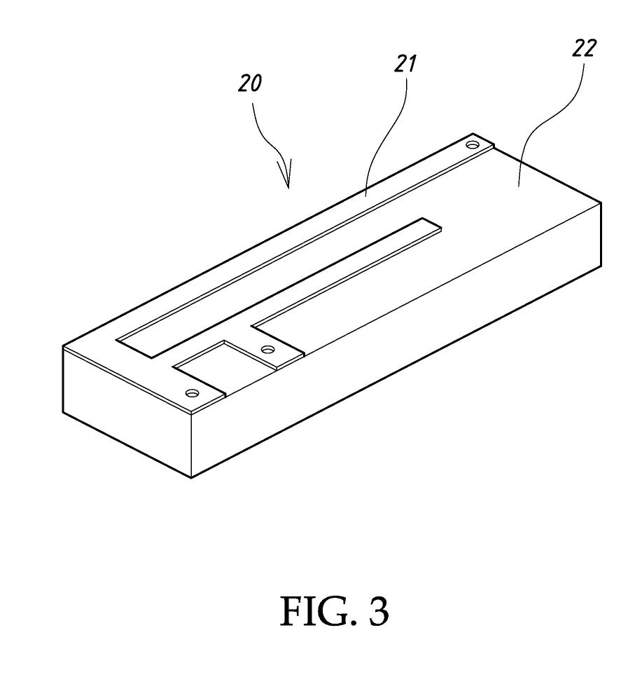

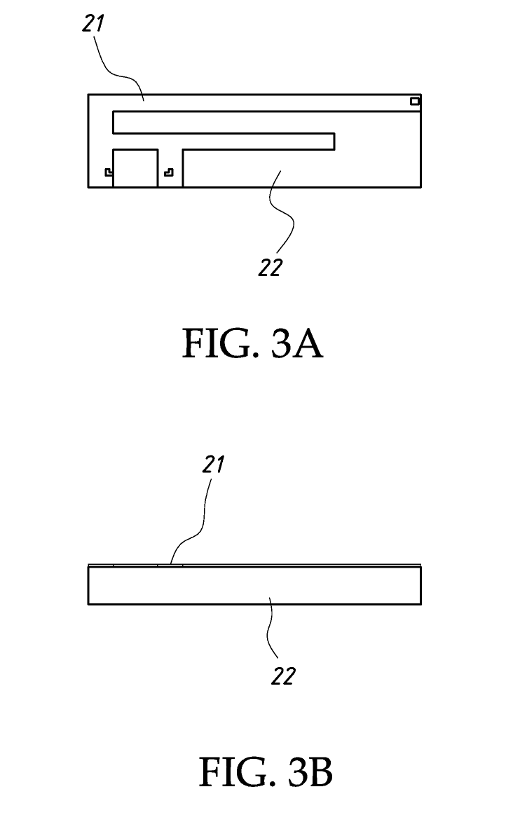

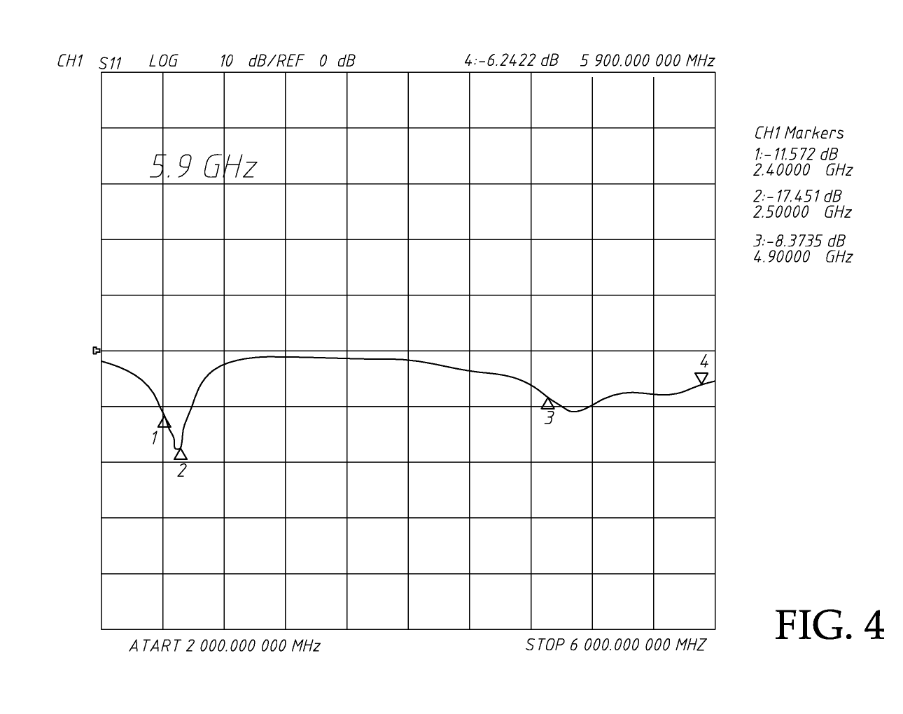

The clear space 12 is provided thereon with the antenna structure 20, as are shown in FIGS. 3, 3A and 3B, the antenna structure 20 includes a radiation element 21 and a fixing plate 22; the fixing plate 22 is made of material for making a printed circuit board, such as FR4PCB, and the radiation element 21 is made from copper foils and is laid out linearly on the surface of the fixing plate 22.

The fixing plate 22 of the antenna structure 20 is provided at the middle of the clear space 12 with a size of 12.9 mm×4 mm×2 mm. The radiation element 21 is an inversed “F” shaped planar antenna having a dual-band function such as the working frequencies of 2.4 GHz˜2.5 GHz and 4.9 GHz˜5.9 GHz to suit a 803.11abg system.

In designing the present invention, in order to meet the requirement of a mobile communication product, the minimum space is used and a good effect can be attained. What is shown in the drawings is the case in simulation of the real situation; it is not like a ceramic antenna that needs a larger clear space to get a good effect which will become inferior during simulation and after assembling in a device; in designing the present invention, this problem has been put in consideration, in order that errors by changing of the effects between that during simulation and that after assembling in a device can be in the minimum scope.

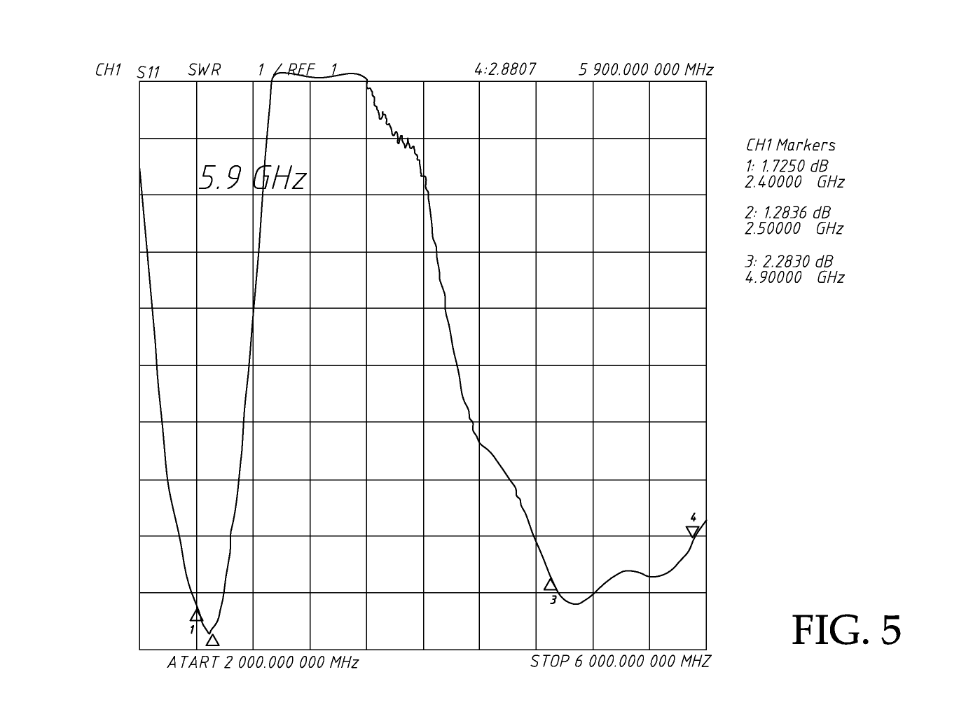

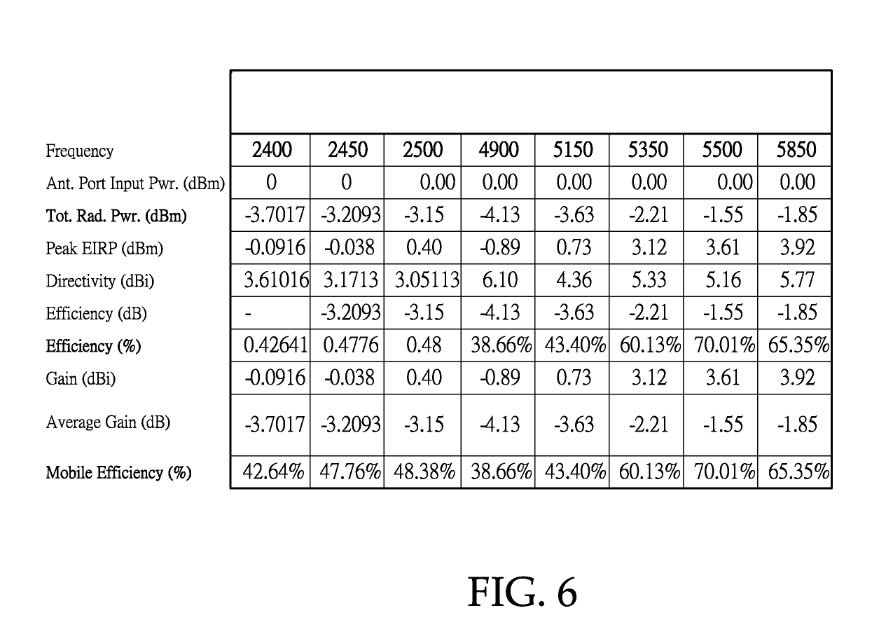

Referring to FIGS. 4, 5 and 6 showing the data of effects in testing of the present invention, we can see that the present invention can have a good effect when in the dual bands of 2.4 GHz˜2.5 GHz and 4.9 GHz˜5.9 GHz.

The present invention mainly has the following advantages:
1) In designing the present invention, the most important goals are reducing cost, making simple of the process of manufacturing, and reducing working hours for production but increasing the superiority of production of the product.
2) Error during testing of the effects between that during simulation and that after assembling in a real mobile communication product is small.
3) The present invention has light weight, small volume and good effect.

In conclusion, the micro antenna structure provided by the present invention is novel and advanced, therefore, what I claim as new and desire to be secured by Letters Patent of the United States is:

1. A micro antenna structure comprising:
a base plate formed thereon a grounding surface and a clear space; and
an antenna structure provided in said clear space and including a radiation element and a fixing plate; said fixing plate being made of material for making a printed circuit board, while said radiation element is made from copper foils and is laid out linearly on said fixing plate.

2. The micro antenna structure as defined in claim 1, wherein said clear space on said base plate is provided at a middle of an edge of said base plate, size of said clear space is 20 mm×4.2 mm.

3. The micro antenna structure as defined in claim 2, wherein said fixing plate of said antenna structure is provided at a middle of said clear space with a size of 12.9 mm×4 mm×2 mm.

4. The micro antenna structure as defined in claim 1, wherein said radiation element of said antenna structure is an inversed “F” shaped planar antenna.
